(19) United States
(12) Patent Application Publication
(10) Pub. No.: US 2017/0335817 A1
(43) Pub. Date: Nov. 23, 2017

(54) INTERNAL COMBUSTION ENGINES INCLUDING ELECTRIC STARTING SYSTEM POWERED BY LITHIUM-ION BATTERY

(71) Applicant: Briggs & Stratton Corporation, Wauwatosa, WI (US)

(72) Inventors: Matthew D. De Lise, Brookfield, WI (US); Kenneth R. Breitenstein, Cedarburg, WI (US)

(73) Assignee: Briggs & Stratton Corporation, Wauwatosa, WI (US)

(21) Appl. No.: 15/520,049

(22) PCT Filed: Oct. 22, 2015
(86) PCT No.: PCT/US15/56881

§ 371 Date: Apr. 18, 2017

Related U.S. Application Data
(60) Provisional application No. 62/067,885, filed on Oct. 23, 2014.

(51) Int. Cl. F02N 11/08; F02N 11/00; F04D 29/02; H01M 2/10; F01P 5/04; F04D 29/52; H01M 10/0525

(52) U.S. Cl. CPC F02N 11/08; F04D 29/522; F02N 11/003; H01M 10/0525; H01M 2/1022; F01P 5/04; F04D 29/023; F01P 2005/046; H01M 2220/00

(57) ABSTRACT

An internal combustion engine includes an engine block including a cylinder, a piston positioned within the cylinder and configured to reciprocate within the cylinder, a crankshaft driven by the piston, a fuel system for supplying an air-fuel mixture to the cylinder, a starter motor configured to initiate rotation of the crankshaft to start the engine, a cover having a vent opening, a blower housing located between the cover and the engine block for directing cooling air toward the engine block, wherein the blower housing comprises a receptacle electrically coupled to the starter motor, a fan configured to draw the cooling air into the blower housing through the vent opening in the cover to cool the engine block, and a rechargeable battery pack removably attached to the receptacle, wherein the rechargeable battery pack is configured to power the starter motor to start the engine.

### CROSS-REFERENCE TO RELATED PATENT APPLICATIONS

This application claims the benefit of U.S. Application No. 62/067,885, filed Oct. 23, 2014, which is incorporated herein by reference in its entirety.

### BACKGROUND

The present invention generally relates to internal combustion engines including electric starting systems and outdoor power equipment powered by such engines, such as lawn mowers, snow throwers, portable generators, etc. More specifically, the present invention relates to small internal combustion engines including electric starting systems powered by a removable, rechargeable lithium-ion battery.

Outdoor power equipment includes lawn mowers, riding tractors, snow throwers, pressure washers, portable generators, tillers, log splitters, zero-turn radius mowers, walk-behind mowers, riding mowers, industrial vehicles such as forklifts, utility vehicles, etc. Outdoor power equipment may, for example use an internal combustion engine to drive an implement, such as a rotary blade of a lawn mower, a pump of a pressure washer, the auger of a snow thrower, or the alternator of a generator, to drive a drivetrain to power one or more wheels, or to drive both an implement and a drivetrain.

Many pieces of outdoor power equipment include engines that are manually started with a recoil starter. To start the engine, the user must manually pull a recoil starter rope.

Other pieces of outdoor power equipment include electric starting systems in which a starter motor powered by a battery starts the engine. Typically, such electric starting systems also include a user-actuated starter switch (e.g., a pushbutton or key switch) and a starter solenoid. The starter solenoid is the connection between a low current circuit including the starter switch and a high current circuit including the starter motor. To start the engine, the user actuates the starter switch, causing the starter solenoid to close so that the battery provides starting current to the starting motor to start the engine. Typically, the battery is a lead-acid battery. The battery may be secured to the outdoor power equipment separate from the engine. For example, the battery may be secured to a mounting plate or deck of a lawn-mower or a pressure washer or to the frame of a riding lawn mower or a portable generator. The battery is typically secured to the outdoor power equipment by fasteners that require tools (e.g., a wrench or socket) to attach the battery to the outdoor power equipment and to remove or loosen the fasteners so the battery can be removed from the outdoor power equipment. Also, the battery includes a pair of terminals to which electrical leads are attached. Tools are also required to attach and remove the electrical leads to the terminals. Lead-acid batteries are filled with a liquid electrolyte, typically a mixture of water and sulfuric acid. The electrolyte is corrosive and may cause harm to eyes and skin. Lead-acid batteries are temperature sensitive, which may result in the engine having difficulty starting or not starting at all in cold weather. Also, a lead-acid battery will run down with the passage of time and may be able to provide power sufficient to start the engine (i.e., lose charge or become completely discharged). Accordingly, a lead-acid battery may need to be replaced seasonally, removed from the outdoor power equipment and stored inside, or otherwise maintained or serviced by a user. Such seasonal replacement or removal is made even more difficult by the fact that lead-acid batteries for use on such equipment are typically heavy and difficult for the user to lift and/or handle.

### SUMMARY

One embodiment of the invention relates to an internal combustion engine including an engine block including a cylinder, a piston positioned within the cylinder and configured to reciprocate within the cylinder, a crankshaft driven by the piston, a fuel system for supplying an air-fuel mixture to the cylinder, a starter motor configured to initiate rotation of the crankshaft to start the engine, a cover having a vent opening, a blower housing located between the cover and the engine block for directing cooling air toward the engine block, wherein the blower housing comprises a receptacle electrically coupled to the starter motor, a fan configured to draw the cooling air into the blower housing through the vent opening in the cover to cool the engine block, and a rechargeable battery pack removably attached to the receptacle, wherein the rechargeable battery pack is configured to power the starter motor to start the engine.

Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings.

FIG. 1 illustrates an isometric view of an internal combustion engine having a removable starting battery thereon in accordance with an exemplary embodiment.

FIG. 2 illustrates a top view of the internal combustion engine of FIG. 1.

FIG. 3 illustrates an isometric view of the internal combustion engine of FIG. 1.

FIG. 3A illustrates an exploded view of a portion of the internal combustion of FIG. 1.

FIG. 4 illustrates an exploded view of the internal combustion engine of FIG. 1.

FIG. 5 illustrates an isometric view of a blower housing for the internal combustion engine of FIG. 1.

FIG. 6 illustrates an isometric view of an engine cover portion of the internal combustion engine of FIG. 1.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Internal combustion engines including electric starting systems powered by a removable, rechargeable lithium-ion battery, as described herein, provide numerous advantages over engines that are manually started and engines including electric start systems powered by a lead-acid battery. Electric starting systems eliminate the need for a manual recoil starter and the need for the user to pull the starter rope to start the engine. Using a removable, rechargeable lithium-ion battery to power the electric starting system eliminates many of the hassles, inconveniences, and shortcomings of systems powered by the lead-acid batteries. As described herein, an exemplary lithium-ion battery is removable from a battery receiver without the use of tools. The relatively lightweight lithium-ion battery is easily attached to and removed from the battery receiver by hand. This is greatly simplified from the process of removing a lead-acid battery from a piece of outdoor power equipment. A user must safely disconnect the electrical leads connected to the terminals of the lead-acid battery, which requires the use of tools. The lead-acid battery must then be removed from its mounting location, typically a frame, plate, or other mounting location separate from the engine. This also may require the use of tools. In preferred embodiments, the battery receiver is a component of the engine itself so the lithium-ion battery is mounted to the engine, rather than a location remote from the engine like a lead-acid battery would be (e.g., to a mounting platform elsewhere on the outdoor power equipment that is separate from the engine). Systems using lead-acid batteries may have the lead-acid battery covered or otherwise out of sight (e.g., under the seat of a riding tractor), requiring the user to remove or move components to access the lead-acid battery, another step which may require the use of tools. The ease of removing the lithium-ion battery makes it easier to limit the battery's exposure to cold temperatures than a lead-acid battery (e.g., on a piece of outdoor power equipment stored in a garage during winter). A user can easily remove the lithium-ion battery and store it in a heated location (e.g., inside the user's home), or keep a second lithium-ion battery in a heated location so that the second lithium-ion battery is available for use if cold temperatures are affecting the operation of the first lithium-ion battery. Disconnecting, removing, reinstalling, and reconnecting a lead-acid battery using tools in similar cold weather operating conditions is a burdensome task not done by a typical user. Also, for pieces of outdoor power equipment used seasonally (e.g., lawn mowers and pressure washers in warm months and snow throwers in cold months), a lead-acid battery may be run down, dead, or otherwise at a level of charge insufficient to start the engine after a season of not being used (e.g., starting a lawn mower for the first time after winter). A user can either store the lithium-ion battery indoors on the battery charger, keeping it both charged and at an appropriate operating temperature or easily remove the lithium-ion battery from the battery receiver without the use of tools, quickly recharge it in the battery charger, and reattach it to the battery receiver without the use of tools to power the electric starting system and start the engine of the outdoor power equipment.

The lithium-ion battery described herein recharges quickly even when completely depleted of charge. In tests, a lithium-ion battery as described herein completely depleted of charge was charged for one minute and was able to provide power sufficient to twice start the engine to which it was subsequently attached. The lithium-ion battery as described herein can be fully charged in sixty minutes and at full charge can provide fifty starts or more of an engine. The lithium-ion battery as described herein is able to provide more than ten starts of an engine after ten minutes of charging.

The lithium-ion battery described herein eliminates concerns related to the corrosive electrolyte of a lead-acid battery, simplifying handling of the battery by the user.

The ability to install the lithium-ion battery without the use of tools and including the battery receiver as a component of the engine itself simplifies assembly of the engine into a piece of outdoor power equipment by an original equipment manufacturer (“OEM”). There is no need for the OEM to use tools to attach the lithium-ion battery to the outdoor power equipment, unlike with a lead-acid battery, and also no need to use tools to connect electrical leads to the terminals of the battery. Also, fewer parts may be required. For example, the wiring harness including the electrical leads attached to the lead-acid battery may be eliminated or simplified in its design and/or routing.

The ease of removing and recharging the lithium-ion battery as described herein also increases end-user comfort with outdoor power equipment not including a manual starting system (e.g., a recoil starter). Because the lithium-ion battery is easily removed without tools and quickly recharged to a charge state sufficient to start the engine, the end user can be confident in being able to start the engine in most circumstances (e.g., absent any issues with the starting system and other engine components other than a dead battery). In preferred embodiments, the lithium-ion battery described herein includes a display that visually indicates to the user the battery's level of charge. An electrical starting system powered by a lead-acid battery that is not able to start the engine can be incredibly frustrating for the end user (e.g., because the lead-acid battery has insufficient charge to start the engine). There is no quick and easy way to determine the level of charge in the lead-acid battery and, if necessary, no quick and easy way to replace or recharge the lead-acid battery. A depleted lead-acid battery needs to be disconnected from the electrical leads with tools, removed from the outdoor power equipment with tools, and be properly disposed of. The end user then must acquire a new lead-acid battery, almost certainly needing to take a trip to the store to do so, install the new lead-acid battery with tools, and connect the electrical leads to the new lead-acid battery with tools.

In some embodiments, the lithium-ion battery is secured to the engine with a fastener (e.g., screw, bolt, etc.) or other securing device (e.g., strap, cover, etc.), but no tools are required to connect and disconnect electrical leads to the battery like with conventional lead-acid batteries.

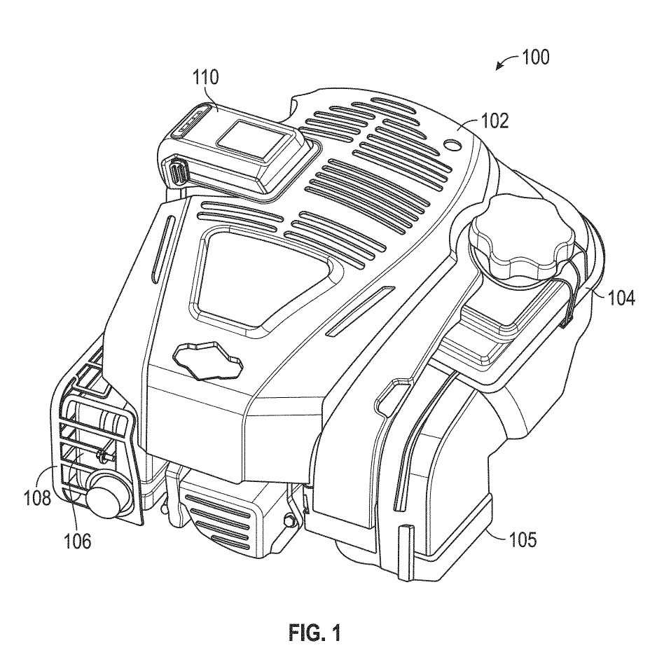

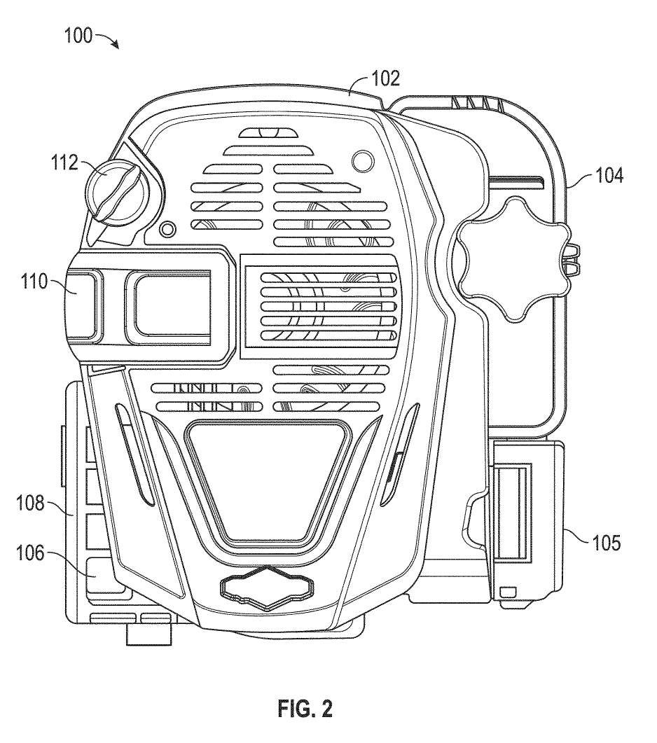

Referring to FIGS. 1 and 2, an internal combustion engine 100 in accordance with an exemplary embodiment is shown. Engine 100 includes a cover portion 102, a fuel tank 104, an air cleaner portion 105 for housing an air cleaner, a muffler 106 surrounded by a muffler guard 108, an oil-fill cap 112, and a removable battery pack 110. As described above, removable rechargeable battery pack 110 is may be a lithium-ion battery pack having one or more lithium-ion cells therein. Alternatively, battery pack 110 could incorporate battery chemistries other than lithium-ion, such as lead acid, nickel metal hydride (NiMH), or nickel cadmium (NiCad). The pack may be removed without the use of tools, e.g., via sliding engagement and/or push-button disengagement from the engine 100. Additionally, removable battery pack 110 may have an indicator visual display to alert the user to the state-of-charge of the battery or provide other relevant information regarding the battery and/or the engine to the user. Battery pack may be mounted on engine 100 at or near the air intake opening (e.g., air vent holes or openings 130) for cooling air where, on conventional general purpose air-cooled engines, the recoil starter would be located. In this context, “near” the air intake opening may be above the opening at any point or on a peripheral side of the opening.

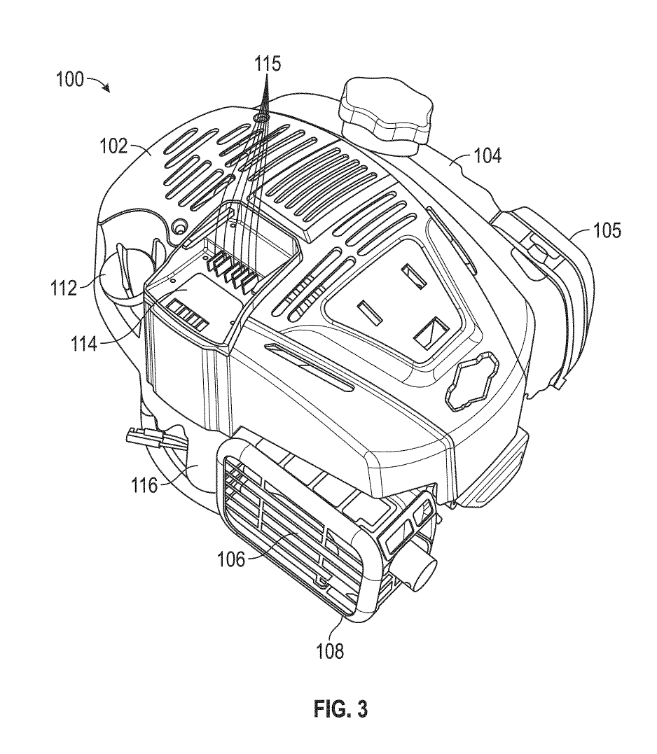

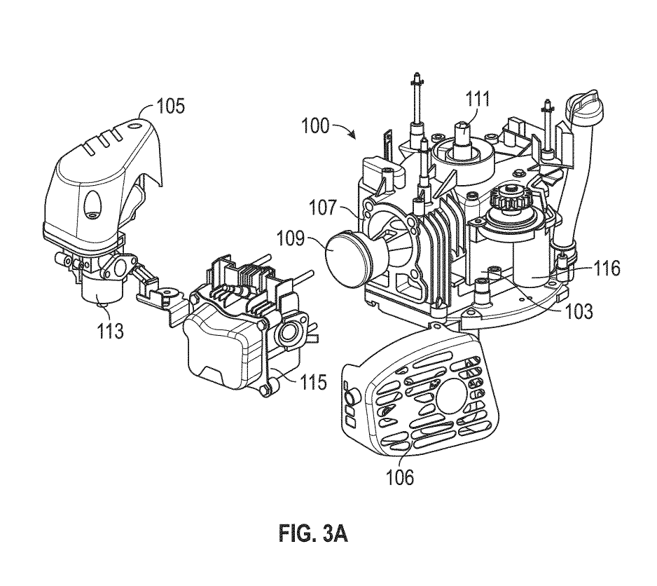

FIG. 3 also illustrates engine 100, but with battery pack 110 removed to expose battery receptacle 114. Battery pack 110 may be slidably engaged with and removed from receptacle 114, but may alternatively be attached and removed via other methods, such as via a strap or clasp-type engagement. Receptacle 114 is configured to accept (e.g., through sliding engagement) removable battery pack 110. Receptacle 114 comprises a plurality of male terminals 115 that are configured to couple with corresponding female terminals (not shown) of removable battery pack 110 or be coupled to corresponding terminals of starting system control circuitry (not shown in FIG. 3). The receptacle 114 and starting system control circuitry are electrically coupled with a starter motor 116 so that the battery pack 110 powers the starter motor 116 to enable starting of the engine 100 when desired.

As illustrated in FIG. 3A, engine 100 also includes an engine block 103 having a cylinder 107, a piston 109, and a cylinder head 115. The piston 109 reciprocates in the cylinder 107 along a cylinder axis to drive a crankshaft 111. The crankshaft 111 rotates about a crankshaft axis. The engine 100 also includes a fuel system 113 for supplying an air-fuel mixture to the cylinder 107 (e.g., a carburetor, an electronic fuel injection system, etc.). In the illustrated embodiment, the cylinder 107 and the cylinder axis are oriented horizontally (i.e., a horizontal cylinder engine). In some embodiments, the cylinder 107 and the cylinder axis can be oriented vertically (i.e., a vertical cylinder engine) or at an angle (i.e., a slanted engine). In some embodiments, the engine includes multiple cylinders, for example, a two cylinder engine arranged in a V-twin configuration.

The engine 100 also includes an electric starting system, which includes the starter motor 116, the receptacle 114, the battery pack 110, and the starting system control circuitry. The starter motor 116 is electrically coupled to the battery pack 110 to be powered by the battery pack 110. When activated in a response to a user input (e.g., via a key switch, a push button, a bail start system, a trigger start system for a pressure washer, other automatic start system, etc.), the starter motor 116 rotates the crankshaft 111 to start the engine. The starter motor 116 is selectively coupled to the crankshaft 111 (e.g., by a movable pinion gear that selectively engages a flywheel ring gear) so that the starter motor 116 may be decoupled from the crankshaft 111 (i.e., does not rotate with the crankshaft 111 after the engine 100 has been successfully started).

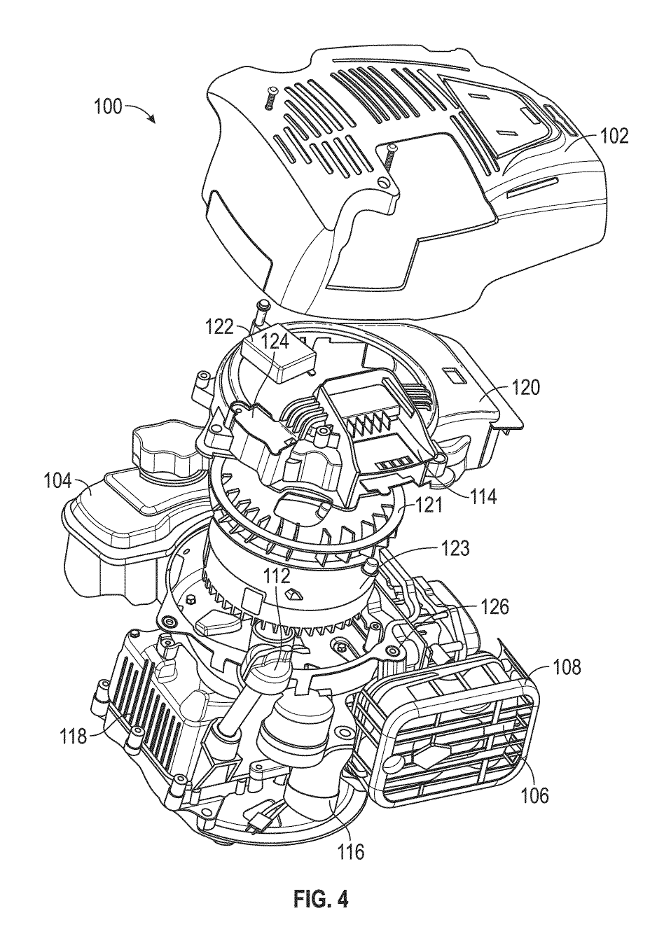

Turning to FIG. 4, an exploded view of engine 100 is shown. FIG. 4 illustrates that receptacle 114 is integrally formed in a blower housing 120 located beneath cover 102. Blower housing 120 acts to direct cooling air from a fan 121 to toward the engine block 103, including the cylinder 107, cylinder head 115, and other portions of the engine subject to high operating temperatures. In some embodiments, the fan 121 is coupled to and rotates with the crankshaft 11 to draw cooling air into the blower housing 120 to cool the engine. In other embodiments, the fan may be driven independently from the crankshaft (e.g., by an electric motor). Blower housing 120 is coupled via an appropriate fastener (e.g., bolts) to a blower scroll 126, which is in turn coupled via similar fasteners to various portions of the engine, such as mounting bosses on engine cylinder block 118. By incorporating receptacle 114 into blower housing 120, cover 102 is able to be further customized to suit different needs and desired ornamental appearances. Additionally, blower housing 120 is generally formed of a higher-strength polymer or other synthetic material than is cover 102, making for a more robust connection platform between removable battery 110 and engine 100 than if the blower housing and cover were formed as a single integral component. For example, blower housing 120 may be formed of a nylon resin, while cover 102 may be formed of a polypropylene material.

In addition to integrally housing receptacle 114, blower housing 120 also contains a mounting platform 124 for secure mounting of starting system control circuitry 122. Starting system control circuitry 122 provides signals to starter motor 116 based upon inputs indicating a desire to start engine 100. Those inputs may come from a user-activated push-button on a pressure washer or portable generator, an actuated bail on a walk-behind lawnmower, tiller, lawn edger, leaf blower, etc. By mounting starting system control circuitry 122 on mounting platform 124, circuitry 122 is protected from the elements and debris under a portion of cover 102 and is located in close proximity to both battery receptacle 114 and starter motor 116.

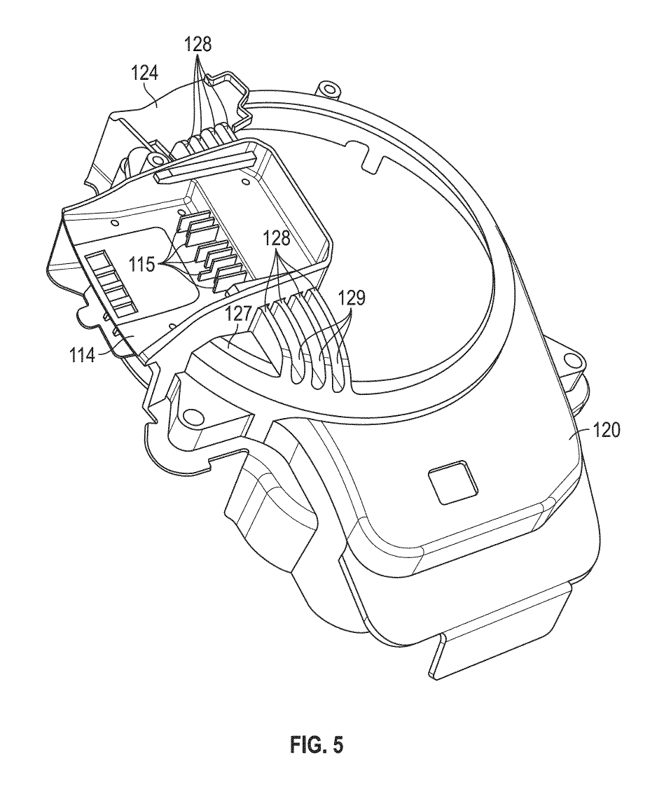

Next, referring to FIG. 5, another view of blower housing 120 is illustrated. Receptacle 114 is not only formed on blower housing 120 at a ring 127, but is also supported by a plurality of ribs 128 that extend from opposite sides of receptacle 114 to portions of ring 127. Ribs 128 have a plurality of openings 129 therebetween to better allow for airflow to fan 121. This configuration increases the stiffness and strength of receptacle 114, but still allows for sufficient airflow through blower housing 120.

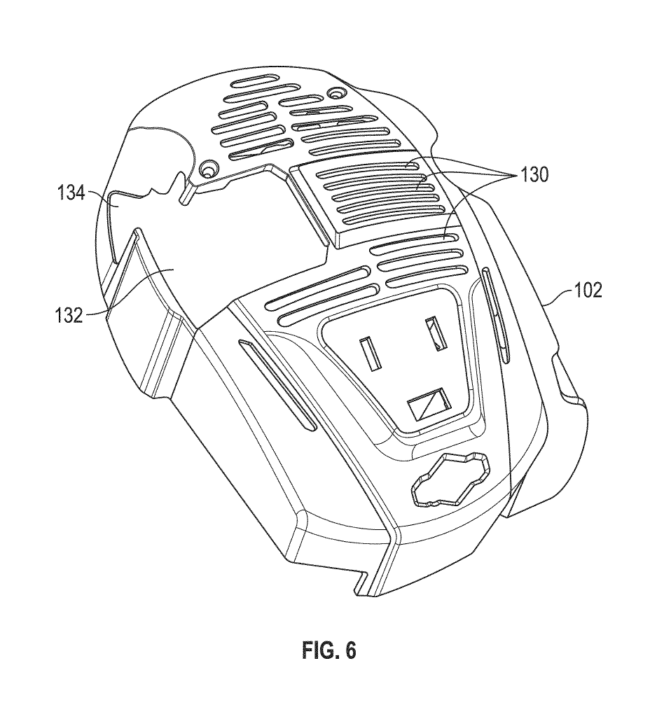

FIG. 6 shows another view of cover 102. Cover 102 contains one or more air vent holes or openings 130, wherein vent holes 130 allow cooling air to enter the blower housing to cool the engine, while still preventing large debris from entering the blower housing. An opening 132 is formed in cover 102 to allow access to receptacle 114, while another opening 134 is formed to allow access to oil cap 112. As discussed above, cover 102 may be customized according to the needs of the customer, so the number, size, and shape of vent holes 130 may be changed, as could the overall shape and size of cover 102. For example, this allows the same engine “base” (i.e., everything but the cover), to be used with covers designed for specific customers in terms of brand identifiers, coloring, or other markings or with covers designed for specific applications in terms of the number, size, or location of the vent openings. This increased modularity in the assembly process can help to reduce costs by allowing engine bases to be finished as needed with the appropriate cover, thereby eliminating the need to stock or manufacture the entire engine to order.

The construction and arrangement of the apparatus, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

We claim:

1. An internal combustion engine, comprising:
an engine block including a cylinder;
a piston positioned within the cylinder and configured to reciprocate within the cylinder;
a crankshaft driven by the piston;
a fuel system for supplying an air-fuel mixture to the cylinder;
a starter motor configured to initiate rotation of the crankshaft to start the engine;
a cover having a vent opening;
a blower housing located between the cover and the engine block for directing cooling air toward the engine block, wherein the blower housing comprises a receptacle electrically coupled to the starter motor;
a fan configured to draw the cooling air into the blower housing through the vent opening in the cover to cool the engine block; and
a rechargeable battery pack removably attached to the receptacle, wherein the rechargeable battery pack is configured to power the starter motor to start the engine.

2. The internal combustion engine of claim 1, further comprising control circuitry for controlling operation of the starter motor.

3. The internal combustion engine of claim 2, wherein the control circuitry is mounted to the blower housing.

4. The internal combustion engine of claim 1, wherein the cover has an opening formed therein to enable access to the receptacle of the blower housing through the opening.

5. The internal combustion engine of claim 1, wherein the rechargeable battery pack is configured to be selectively inserted into and removed from the receptacle without tools.

6. The internal combustion engine of claim 1, wherein the cover is formed from polypropylene.

7. The internal combustion engine of claim 1, wherein the blower housing is formed from nylon resin.

8. The internal combustion engine of claim 1, wherein the rechargeable battery pack includes at least one lithium-ion cell.

9. The internal combustion engine of claim 1, wherein the vent opening is one of a plurality of vent openings included in the cover.

10. The internal combustion engine of claim 1, wherein the rechargeable battery pack is located near the vent opening when attached to the receptacle.

11. The internal combustion engine of claim 1, wherein the rechargeable battery pack is slidably engaged with and removed from the receptacle.

12. The internal combustion engine of claim 1, where the blower housing further comprises a ring and the receptacle is supported by a plurality of ribs extending from opposite sides of the receptacle to portions of the ring.

13. The internal combustion engine of claim 12, further comprising:
control circuitry for controlling operation of the starter motor;
wherein the blower housing further comprises a mounting platform to which the control circuitry is mounted.

14. The internal combustion engine of claim 1, further comprising:
control circuitry for controlling operation of the starter motor;
wherein the blower housing further comprises a mounting platform to which the control circuitry is mounted.
